(19) United States
(12) Patent Application Publication
(10) Pub. No.: US 2008/0121214 A1
(43) Pub. Date: May 29, 2008

(54) Rapid Multiple Spark Ignition

(75) Inventors: Dietmar Bertsch, Aspach (DE); Wilfried Schmolla, Dietzenbach (DE); Harold Winter, Taunusstein (DE)

Correspondence Address: FITCH, EVEN, TABIN & FLANNERY, P. O. BOX 18415, WASHINGTON, DC, 20036, US

(73) Assignee: DaimlerChrysler AG, 70567 Stuttgart (DE)

(21) Appl. No.: 11/791,536

(22) PCT Filed: Nov. 12, 2005
(86) PCT No.: PCT/EP05/12144

§ 371 Date: Aug. 15, 2007

(30) Foreign Application Priority Data
Nov. 25, 2004 (DE) 10 2004 056 844.8

(51) Int. Cl. F02P 3/01; F02P 5/00

(52) U.S. Cl. 123/406.12; 123/594

(57) ABSTRACT

The invention relates to rapid multiple ignition, in which the maximum breakdown voltage for the spark breakdown is available a number of times during an ignition time window. The ignition system operates with a DC converter with which the voltage of the on-board vehicle electrical system is increased, and with rod-type ignition transformers whose minimized ignition coils permit rapid recharging. The ignition electronics operate with a power output stage which charges the rod-type ignition transformer by switching a power switch in the ground path of the primary winding. The output stage power switch is actuated by a time control arrangement which clocks the power switch for charging the rod-type ignition transformer and connects the primary side of the ignition transformer to ground for a prespecified time period in order to achieve the spark breakdown after charging of the ignition transformer.

The invention relates to a method and to an ignition system for generating several spark breakdowns at a spark plug. In this case, the spark breakdowns are generated a number of times one after the other within an ignition time window.

Many investigations which were directed at systems for generating a multiple spark breakdown at a spark plug have been made in ignition technology. Such ignition systems and ignition methods were, for example, called “multiple charge systems” or multiple spark ignition. Accordingly, there are a large number of patent publications which form this generic type and of which the most important are briefly discussed in the text which follows.

DE 100 34 725 B4 discloses an ignition method and an ignition system for controlling ignition in an internal combustion engine, which system generates a voltage pulse by multiple interruption of the primary current of an ignition coil on the secondary side of the ignition coil and therefore a spark breakdown at the electrodes of the downstream spark plug.

In this case, the control system for generating the spark breakdown operates with a complex measurement sensor system with which the secondary current is measured and monitored. If, after the initial spark breakdown, the secondary current falls below a monitored threshold value within the ignition time window, the ignition coil is recharged and a new spark breakdown is initiated. In this case, the monitored threshold value is a function of the engine speed and the ambient temperature.

Multiple charge systems of the same generic type are also known from US patent documents U.S. Pat. No. 6,378,513 B1 and U.S. Pat. NO. 6,367,318 B1.

In U.S. Pat. No. 6,378,513 B1, the secondary current threshold which is already mentioned in DE 100 34 725 B4 is defined as a function of the energy which has already been drawn from the secondary coil of the ignition coil. As a result, the time intervals for the multiple ignitions can be kept variable and excessively high energy being applied to the combustion cylinders on account of the multiple ignition is prevented.

In U.S. Pat. No. 6,367,318 B1, a different strategy is followed in order to prevent unnecessary application of energy on account of the multiple ignition. A decision as to whether the fuel mixture has already been ignited is made using an ion current measurement means, which measures the secondary current across the electrodes of the spark plug, by means of a control logic and taking into account the threshold value of the ion current. If the decision is made that the fuel mixture is already ignited, the multiple charge process is terminated.

Alternating current ignition, with which it is possible to control the spark duration within an ignition time window, is also known. In DE 101 21 993 A1, the primary current is interrupted a number of times by means of a time control arrangement and superimposed maximum-current limiting of the primary current, and an AC voltage is therefore generated on the secondary side of the ignition coil by means of a reverse-blocking diode in the primary current path in accordance with the flyback converter principle. By means of a re-ignition reserve which is inherent on account of the design of the ignition coil, care is taken that re-ignition can be carried out when the ignition spark is extinguished.

The abovementioned ignition systems all have their specific advantages but naturally also have their specific limitations.

The abovementioned ignition systems and ignition methods are not suitable in low-load operation of internal combustion engines which are driven with a high excess of oxygen, that is to say so-called lean-burn engines or so-called stratified charge methods (fuel stratified injection) for internal combustion engines. In the case of these engines, misfires are very highly noticeable at low rotational speeds and with low loads. In this case, the risk of misfires increases as the amount of fuel introduced falls. In the low-load range, the ability to ignite the mixture is extremely critical. Even the installation position of the grounding clip of the spark plug now has a decisive influence on whether stratified charge can still be reliably ignited or not. If spark failure occurs, this is very highly noticeable on account of extremely irregular running of the engine at the low rotational speeds during idling or in the low-load range. Since no conclusive ignition methods have been found to date, lean-burn engines have therefore been driven in a quasi over-enriched manner in the low-load range. However, a large portion of the hoped-for fuel savings is lost again as a result. The greater the power class of the internal combustion engine, the greater is this partial-load problem in lean-burn engines.

One objective of this invention is therefore to specify an ignition method and an ignition system with which the tolerable operating points of lean-burn operation of internal combustion engines can be shifted further into the low-load range and further to low engine speeds.

This objective is achieved by a method and an ignition system according to the independent claims. Further advantageous embodiments of the invention are disclosed in the subclaims and in the description and also in the exemplary embodiments.

The solution is achieved with rapid multiple ignitions in which the maximum breakdown voltage for the spark breakdown is available a number of times during an ignition time window. The ignition system operates with a DC converter with which the voltage of the on-board vehicle electrical system is increased, and with rod-type ignition transformers whose minimized ignition coils permit rapid recharging. The ignition electronics operate with a power output stage which charges the rod-type ignition transformer by switching a power switch in the ground path of the primary winding. The output stage power switch is actuated by a time control arrangement which clocks the power switch for charging the rod-type ignition transformer and connects the primary side of the ignition transformer to ground for a prespecified time period in order to achieve the spark breakdown after charging of the ignition transformer.

There are several ways of implementing the time control arrangement. In one embodiment, the time control arrangement can be implemented in a separate ignition controller which takes over actuation of the power output stage of the driver circuit for charging the ignition transformer. In this case, a superordinate engine controller prespecifies to the ignition controller an ignition time window for the start and end of rapid multiple injection.

However, ignition control may advantageously be implemented in a controller which is present in the motor vehicle in any case. The engine controller is particularly suitable here. If ignition control is implemented in the engine controller, it is not only possible to dispense with a separate ignition controller but the signals for the ignition time window and for actuating the power output stage can also be combined and standardized. This considerably simplifies signal processing.

The adapted small coils of the rod-type ignition transformers, together with the DC converter, permit rapid recharging. The DC converter, which as a step-up controller steps up the on-board vehicle electrical system voltage for the purposes of ignition, supplies to the primary side of the rod-type ignition transformer an input voltage which is considerably greater than the customary on-board vehicle electrical system voltage of nominally 14 V. A primary-side input voltage of at least 28 volts has proven favorable. In principle, the higher the primary-side input voltage, the faster the ignition coils are recharged.

The power electronics and the rod-type ignition transformer are actuated and dimensioned in such a way that the maximum breakdown voltage for a spark breakdown at the spark plug is reached at least 3 times within the ignition time window of the internal combustion engine in question. A design in which the maximum breakdown voltage for the spark breakdown is applied 10 to 12 times within the ignition time window has proven more favorable.

Actuation and dimensioning in such a way that ignition is performed at least three times with a complete through-voltage in the time which is required for the fuel to reach the electrodes of the spark plug from the injection valve have proven particularly favorable.

In one preferred embodiment of the ignition system according to the invention and the ignition method according to the invention, the ignition electronics, that is to say primarily the power switch with the associated actuating electronics for firing the spark plug, are, in addition to the ignition transformer, integrated in a rod-type ignition transformer. In this case, the functions of the ignition electronics are combined in an integrated circuit. This integrated circuit can then be addressed by the engine electronics with a deterministic bus system. Existing engine electronics then do not have to be adapted and can, as previously, also only transmit the ignition time window to the ignition electronics.

The advantages mainly achieved by the invention can be found in the improved ability to ignite fuel injections which are difficult to ignite. Therefore, the possible operating points of direct-injection gasoline engines can be extended to lower rotational speeds and to low-load ranges which have not been reached to date. Misfires are reliably avoided at these operating points, which have been largely inaccessible to date, of the direct gasoline injectors. Finally, in addition to improved rotation of the engines, better utilization of fuel is achieved since it is possible to dispense with over-enrichment at low rotational speed ranges, as has been customary to date.

A further advantage is that the question of successful ignition of the injected fuel no longer depends so greatly on the installation position of the grounding clip of the spark plug used. It is therefore possible to dispense with measures such as, for example, defined thread notches which ensure that the grounding clip of the spark plug is always installed with the same rotation position in relation to the fuel injector.

In the text which follows, the invention will be explained in greater detail with reference to illustrations, in which:

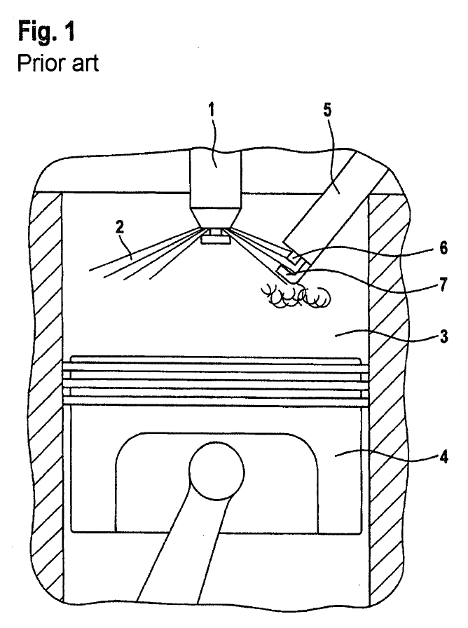

FIG. 1 shows the structural conditions in the combustion chamber of an internal combustion engine from the prior art,

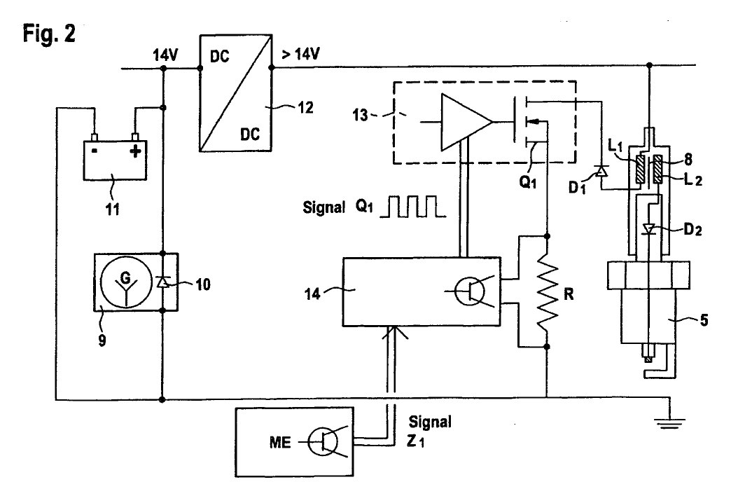

FIG. 2 shows an ignition system according to the invention,

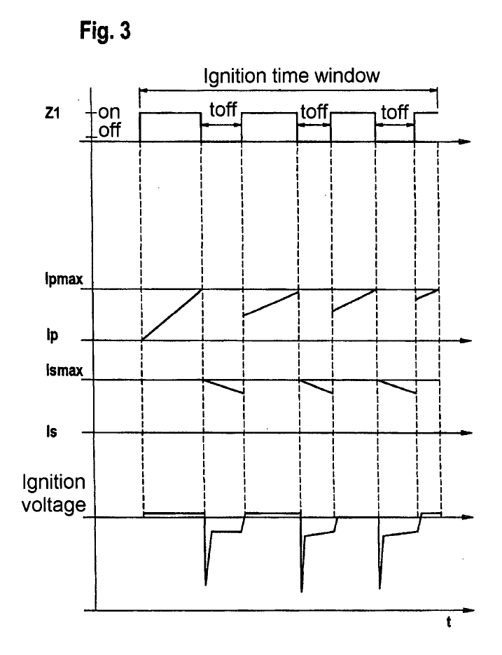

FIG. 3 shows a first timing diagram for one exemplary embodiment of the ignition method according to the invention,

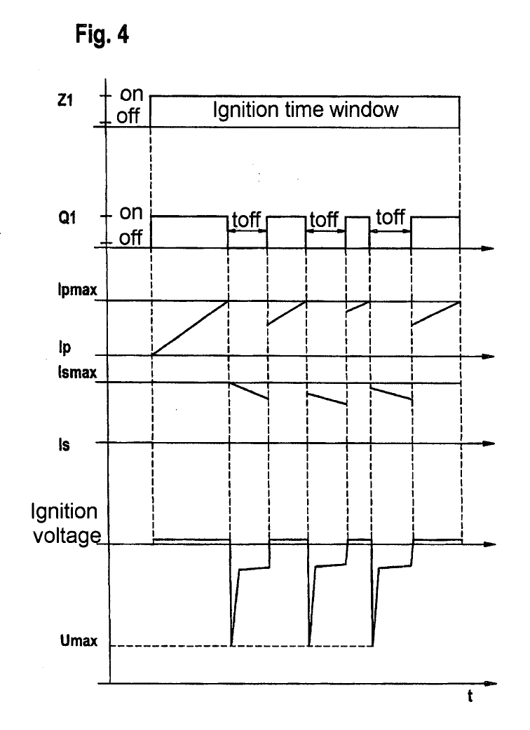

FIG. 4 shows a second timing diagram for one exemplary embodiment of the ignition method according to the invention, and

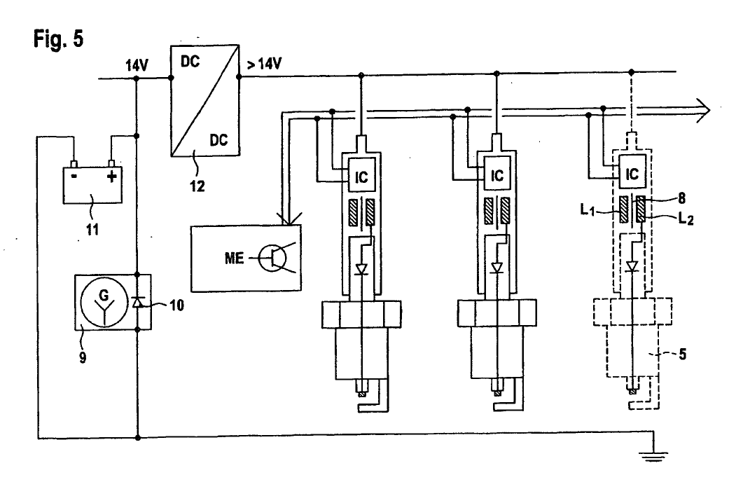

FIG. 5 shows one preferred ignition system according to the invention on the basis of integrated rod-type ignition transformers.

The causes of the problems which have been encountered in known ignition systems in the case of engines with direct gasoline injection, with lean-burn engines or with stratified charging methods will be briefly explained below with reference to the illustration in FIG. 1. The abovementioned types of engine introduce the fuel 2 into the combustion chamber 3 of the engine via an injection valve 1 under high pressure. Ignition of the fuel is matched to the position of the piston 4 in the cylinder bore and to the respective operating cycle in which the engine is currently located. In this case, it should be possible to determine the ignition time in as controlled a manner as possible and ignition is performed with auxiliary ignition energy which is introduced into the internal combustion engine by a spark of a spark plug 5. In this case, the spark gap of a spark plug runs between a central anode 6 and one or more grounding clips 7 which are connected as cathodes. It has now been found that the position of the grounding clip is decisive for successful ignition of the injected fuel at critical operating points of the internal combustion engine. Misfires are produced at low engine speeds and in the low-load range of the internal combustion engine particularly when a spark plug has been installed in such a way that one of its grounding clips shields the anode from the injected fuel. It has not been possible to reliably prevent these misfires with the multiple ignition systems known to date. The invention starts at this point.

FIG. 2 shows a schematic illustration of the invention. The on-board vehicle electrical system voltage of nominally 14 V, which is generated by an on-board vehicle electrical system generator 9 with an integrated rectifier bridge 10 and by an on-board vehicle electrical system battery 11 and for its part is increased to a voltage of greater than 14 V by a DC converter 12, is applied to a transformer, which is in the form of an ignition transformer 8 with a primary winding L1 and a secondary winding L2, so as to be connected to ground via a semiconductor power stage 13 and a diode D1. The secondary side L2 of the ignition transformer is connected to the electrodes of a spark plug 5 via a switch-on suppression diode D2. The spark plug and the ignition transformer are shown as an integrated rod-type ignition transformer in the illustrated exemplary embodiment. This is an advantageous design variant of the invention. In a less advantageous embodiment of the invention, the ignition transformer and the spark plug can also be designed as components which are separate from one another and are connected to one another via electrical lines. The primary side L1 of the ignition transformer is connected to the positive voltage rail of the on-board vehicle electrical system voltage with one of its ends and, at its second end, is connected to the ground line of the on-board vehicle electrical system voltage by way of a semiconductor power stage and a current sensor which is in the form of a measurement resistor R here. The semiconductor power stage 13 is actuated by an ignition controller 14. The ignition controller, the semiconductor power stage and the current sensor are formed separately in one possible exemplary embodiment of the invention. The invention is not restricted to this embodiment. The current sensor used may also be a clip-on ammeter with which the current in the primary coil is measured. The power stage does not necessarily have to be in the form of a semiconductor power stage. The separation between the ignition controller and engine controller ME is more theoretical and in practice depends on practical conditions. In particular, the ignition controller and engine controller may be formed as one unit. However., integrated ignition electronics which are integrated in a rod-type ignition transformer as an integrated circuit are preferred, as will be explained further in conjunction with FIG. 5.

The functioning and actuation of the ignition system according to the invention as per FIG. 2 is explained in greater detail in the text which follows in conjunction with the timing diagrams from FIG. 4. The superordinate engine controller ME sends a signal Z1 to the controller 14 of the ignition electronics as an identifier for the ignition time window. Charging of the ignition transformers 8 is triggered by the signal Z1 for the ignition time window. Charging is performed in accordance with the flyback converter principle via the primary coil L1 and the diode D1 by means of a power switch Q1, which is clocked by the controller of the ignition electronics, in the power output stage 13. For the sake of simplicity, the clock signal in FIG. 4 is likewise designated Q1. The power switch is preferably a semiconductor switch, in particular a MOSFET or an IGBT. In its connected position (on), the primary coil L1 is conductively connected to ground. The primary current Ip rises to a maximum value Ipmax. If the maximum primary current is reached, no further energy can be stored in the ignition transformer. The ignition transformer has to be matched to the electrode pair of the connected spark plug by way of its two coils and their transmission ratio and also their coupling factor. The energy content of the ignition transformer and the transmission ratio of the two coils in each case have to be sufficient to reach the breakdown voltage for spark breakdown and an adequate combustion duration of the spark. In the case of a known supply voltage through the DC converter 12 and in the case of known coil constants of the ignition transformer, it is in principle possible to calculate the time after which the maximum primary current will be reached. Moreover, the charging time can also be experimentally determined by measurements. That is to say, spark breakdown at the electrodes of the spark plug can be achieved with a pure time control arrangement by clocking the power switch Q1, in each case after a switch-on time ton for reaching the maximum primary current Ipmax, by switching off the power switch for a prespecified time toff.

During the time period toff, the current Is in the secondary coil of the ignition transformer will drop. The time period toff is therefore selected to be small enough that there is no risk of the spark being extinguished due to a lack of an excessively low ignition voltage.

In a more complex actuation arrangement, the switching times for clocking the power switch Q1 can be optimized. To this end, the recharging process can be optimized, for example with primary current measurement. The amount of energy still stored in the primary coil is specifically decisive for the recharging process. This in turn depends on the energy consumed by the spark, and the consumed energy depends on the conditions, such as temperature, pressure, moisture, in the combustion chamber. The consumed energy critically depends, in particular, on whether spark breakdown occurs at all at the first attempt. If only a little energy has been drawn from the ignition transformer, the recharging operation does not last as long as complete charging. However, with a pure time control arrangement for achieving the spark breakdown, it is not possible to determine for the recharging operation the earliest time from which the primary current has again reached its maximum value from which ignition can be restarted. It is therefore advantageous to add additional maximum current monitoring for the primary current and thus to trigger the time for switching off the power switch and therefore the ignition time at the time for reaching the maximum primary current. The recharging operations can therefore be optimally matched to the residual energy content in the ignition transformer, and this shortens the recharging times and therefore permits more re-ignition operations within the time window.

In the most convenient embodiment, secondary current determination or ion current measurement can also be performed at the electrodes of the spark plug, with the result that it is also possible to establish whether the ignition spark is still burning. If it is prematurely extinguished, this can be detected by secondary current determination and recharging of the ignition transformer can be immediately started, even before the time period toff of the time control arrangement starts.

In the lowermost timing diagram in FIG. 4, the voltage profile at the electrodes of the spark plug, as results from actuation by the ignition electronics, is plotted by way of example for the sake of completeness. The maximum ignition voltage Umax for achieving the spark breakdown is always available when the power switch Q1 is switched off by virtue of the induction pulse which is then active. This maximum ignition voltage Umax is in this case reached a number of times within an ignition time window; 3 times in the case of the exemplary embodiment shown in FIG. 2.

As already mentioned in the discussion relating to FIG. 2, there are several developments for implementing the invention. FIG. 5 shows a more highly integrated embodiment of an ignition system according to the invention. Furthermore, the on-board vehicle electrical system voltage is increased to a voltage level considerably above 14 volts by a step-up controller and the primary side of the rod-type ignition transformers is supplied with said voltage. However, distribution of the functions for ignition control is more highly integrated than in the exemplary embodiment as per FIG. 2. The functions for charging the rod-type ignition transformers and functions for achieving the spark breakdown are preferably combined in an integrated circuit IC and integrated in the housing of the rod-type ignition transformers. These are mainly the power output stage with the power switch Q1 and the flyback converter diode D1 and also the actuation logic of the power output stage. The integrated circuits are actuated using signals via data lines of a bus system or via serial data lines. The integrated circuits of the ignition electronics are connected to the engine controller ME, such that they can communicate, via these data lines.

As regards the method for actuating ignition, this permits largely flexible execution. Both the integrated circuits and the engine controller have their own intelligence in the form of application programs which are each implemented in executable form in a microprocessor of the integrated circuits and first precisely in the engine controller. This makes it possible, by means of the application programs, to optimally match distribution of the control functions and therefore distribution of the method steps for achieving successful ignition to the hardware conditions applicable in each case by means of programming the application programs. Therefore, the ignition system as per FIG. 5 can be used to implement both an ignition method as has already been discussed in conjunction with FIG. 4 and also an ignition method as will be discussed in conjunction with FIG. 3.

The ignition method according to the timing sequence as per FIG. 3 differs from the ignition method as per FIG. 4 mainly by virtue of the combination of the two signals Z1 for the ignition time window and Q1 for clocking the power switch at the output of the power output stage. According to the method as per FIG. 3, the signal Z1 therefore contains both the information about the ignition time window and the information relating to ignition of the spark plug and recharging of the ignition transformer. In this case, the control signal is applied, for example, to the power switch of the integrated circuit IC to which the ground current path of the primary winding of the rod-type ignition transformer is connected. The signal itself is preferably generated in the integrated circuit. The information relating to the construction of the signal, such as beginning and end of the ignition time window and position of the switch-off times toff for generating spark breakdowns after charging of the ignition transformer, is preferably determined in the engine controller and transmitted in coded form via the data line between the engine controller and the integrated circuit to said integrated circuit for further processing. Combination of the signals relating to the ignition time window, charging of the ignition coil and ignition of the spark breakdown into one signal reduces the outlay which is otherwise required for coordinating the individual signals with one another.

1. An ignition system for an internal combustion engine, comprising at least one voltage supply, at least one ignition transformer (8), at least one spark plug (5) and at least one control logic (ME, 13), with the control logic being used to switch a power switch (Q1) in the ground path of the primary winding (L1) of the ignition transformer, as a result of which the ignition transformer is charged and discharged a number of times within an ignition time window,
characterized
in that the output voltage of the voltage supply is stepped up by a DC converter (12) and is applied to the primary winding of the ignition transformer,
and in that the power switch is switched on and off a number of times within an ignition time window by a time control arrangement which is implemented in the control logic (ME, 13).

2. The system as claimed in claim 1, characterized in that the control logic comprises a separate ignition controller and a superordinate engine controller.

3. The system as claimed in claim 2, characterized in that the time control arrangement is implemented in the ignition controller (13, IC).

4. The system as claimed in claim 1, characterized in that the control logic is formed in an integrated manner with the engine controller.

5. The system as claimed in claim 4, characterized in that the time control arrangement is implemented in the engine controller.

6. The system as claimed in claim 1, characterized in that the ignition coil is a rod-type ignition transformer.

7. The system as claimed in claim 6, characterized in that at least one part of the control logic (13, ME) and the power switch (Q1) are combined in an integrated circuit (IC) and are integrated in the housing of the rod-type ignition transformer.

8. An ignition method for an internal combustion engine, in which:
an ignition coil is charged with a voltage supply by a primary current (Ip) being switched through a primary winding (L1) of an ignition coil (8),
a first spark breakdown is generated at a spark plug (5) by the primary current (Ip) being interrupted, and
the ignition coil is recharged after the first spark breakdown by the primary current (Ip) being reestablished,
characterized
in that the output voltage of the voltage supply is stepped up to a voltage level higher than 14 volts by a DC converter,
and in that the spark breakdown is generated by a time control arrangement with prespecified breakdown times (toff) for the primary current (Ip).

9. The method as claimed in claim 8, characterized in that maximum current monitoring for the primary current (Ipmax) is superimposed on the time control arrangement.

10. The method as claimed in claim 8, characterized in that secondary current monitoring is superimposed on the time control arrangement.

11. The method as claimed in claim 8, characterized in that the time control arrangement operates with two signals
one signal (Z1) for the ignition time window and one signal (Q1) for switching the power switch.

12. The method as claimed in claim 8, characterized in that the information relating to the ignition time window and the information relating to the switching of the power switch is contained in one signal.

13. The method as claimed in claim 8, characterized in that at least 3 spark breakdowns are generated within an ignition time window.

14. The method as claimed in claim 8, characterized in that 10 to 12 spark breakdowns are generated within an ignition time window.

15. The method as claimed in claim 8, characterized in that at least 3 spark breakdowns are generated in the time period which is required for the injected fuel to reach the electrodes of the spark plug from the injection nozzle.

16. The use of the ignition system as claimed in claim 1 in an internal combustion engine with direct gasoline injection.

17. The use of the ignition method as claimed in claim 8 in an internal combustion engine with direct gasoline injection.
